(19) United States
(12) Patent Application Publication
(10) Pub. No.: US 2026/0145932 A1
(43) Pub. Date: May 28, 2026

(54) HYDROGEN PRODUCTION FROM HYDROGEN SULFIDE

(71) Applicant: Baker Hughes Oilfield Operations LLC, Houston, TX (US)

(72) Inventor: Sunder Ramachandran, Sugar Land, TX (US)

(21) Appl. No.: 18/958,424

(22) Filed: Nov. 25, 2024

(51) Int. Cl. C01B 3/06; C01B 17/05

(52) U.S. Cl. CPC C01B 3/06; C01B 17/05

(57) ABSTRACT

A method of producing hydrogen gas and separating sulfur from hydrogen sulfide including contacting the hydrogen sulfide with a catalyst in an aqueous solution to form a hydrogen gas and a reaction solution including sulfur; mixing the reaction solution and a sulfur solvent to form a sulfur solution; separating the sulfur solution into a first stream including the aqueous solution and a second stream including sulfur; and precipitating sulfur from the second stream.

### BACKGROUND

Hydrogen sulfide is a colorless gas with an offensive odor. It is soluble in water and oils. Hydrogen sulfide is often encountered in the oil and gas industry. It can occur naturally as a component of formation gases. Thermal degradation of organic materials and sulfate reducing bacteria can also produce hydrogen sulfide. Hydrogen sulfide is corrosive, toxic, and flammable. Desired is an economical method of producing hydrogen gas and separating sulfur from hydrogen sulfide.

### SUMMARY

An embodiment of a method of producing hydrogen gas and separating sulfur from hydrogen sulfide including contacting the hydrogen sulfide with a catalyst in an aqueous solution to form a hydrogen gas and a reaction solution comprising sulfur; mixing the reaction solution and a sulfur solvent to form a sulfur solution; separating the sulfur solution into a first stream comprising the aqueous solution and a second stream comprising sulfur; and precipitating sulfur from the second stream.

### BRIEF DESCRIPTION OF THE DRAWINGS

The following descriptions should not be considered limiting in any way.

FIG. 1 schematically shows a method of producing hydrogen gas and separating sulfur from hydrogen sulfide as disclosed herein.

### DETAILED DESCRIPTION

Recovery of sulfur formed by the catalytic decomposition of hydrogen sulfide to hydrogen and gaseous diatomic sulfur may present a complicated technological challenge, which can undermine the economic feasibility of catalytic decomposing hydrogen sulfide to form hydrogen and gaseous diatomic sulfur at an industrial scale. Provided is an economical method of producing hydrogen gas and separating sulfur from hydrogen sulfide.

A method of producing hydrogen gas and separating sulfur from hydrogen sulfide includes contacting the hydrogen sulfide with a catalyst in an aqueous solution to form a hydrogen gas and a reaction solution including sulfur. The method further includes mixing the reaction solution and a sulfur solvent to form a sulfur solution. The method further includes separating the sulfur solution into a first stream including the aqueous solution and a second stream including sulfur and precipitating sulfur from the second stream.

A detailed description of one or more embodiments of the disclosed apparatus and method are presented herein by way of exemplification and not limitation with reference to the Figures.

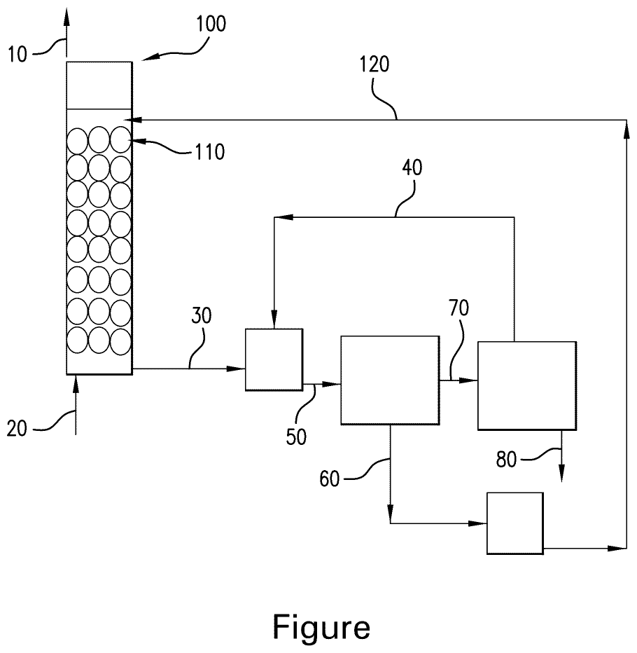

FIG. 1 schematically shows a method of producing hydrogen gas 10 and separating sulfur from hydrogen sulfide 20 as disclosed herein. A reactor 100 includes a catalyst 110 in an aqueous solution 120, to which the hydrogen sulfide 20 is fed. Contacting the hydrogen sulfide 20 with the catalyst 110 in the aqueous solution 120 forms hydrogen gas 10 and a reaction solution 30 including sulfur.

The catalyst 110 may include stainless steel, palladium, ruthenium, indium phosphide, molybdenum disulfide, or a combination thereof. The catalyst may also include nickel, cobalt, or a combination thereof. The metal catalyst can include a support, for example, including alumina, silica, or a combination thereof

The aqueous solution 120 may include monoethanolamine, hydrazine, sodium carbonate, potassium carbonate, ammonium carbonate, or a combination thereof.

The method may include contacting the hydrogen sulfide 20 with the catalyst 110 in the aqueous solution 120 at a temperature of 0 to 200° C., 15 to 200°C., or 20° C. to 22° C.

Contacting the hydrogen sulfide 20 with the catalyst 110 in the aqueous solution 120 can be conducted in a fixed bed, continuous fixed bed, or fluidized bed.

The reaction solution 30 including sulfur is mixed with a sulfur solvent 40 to form a sulfur solution 50.

The sulfur solvent 40 may include toluene, 1-butyl-3-methylimidazolium hexafluorophosphate, 1-butyl-3-methylimidazolium tetrafluoroborate, 1-hexyl-3methylimidazolium tetrafluoroborate, carbon disulfide, carbon tetrachloride, quinoline, chlorobenzene, p-xylene, cyclohexane, or a combination thereof.

The sulfur solvent 40 may include methanol, water, and a heavy polyamine.

The sulfur solvent 40 may include an aromatic solvent, an alcohol, aminoethylpiperazine, and diethylenetriamine. The sulfur solvent may include, for example, 10 to 30 weight percent (wt %) light aromatic naphtha, 10 to 30 wt % 1,2,4-trimethylbenzene, 10 to 30 wt % methanol, 10 to 30 wt % aliphatic amine, 5 to 10 wt % butanol, 1 to 5 wt % 1,2,3-trimethylbenzene, 1 to 5 wt % 1,3,5-trimethylbenzene, 1 to 5 wt % xylene, and 1 to 5 wt % diethylenetriamine. Properties of the sulfur solvent may include, for example, density of 0.89 kilograms/liter, flash point (Tag Closed Cup) of 22° C., pour point of −45° C., and pH (5% in water/isopropyl alcohol) of 11.

The sulfur solvent 40 may include a polyethylene polyamine, aminoethylpiperazine, a fatty amide, or a combination thereof.

The sulfur solvent 40 may include an aromatic, aliphatic hydrocarbon organic solvent.

The sulfur solvent 40 may include chlorobenzene, toluene, p-xylene, cyclohexane, or a combination thereof.

The sulfur solution 50 can be separated into a first stream 60 and a second stream 70 including sulfur. The first stream 60 can be purified to provide aqueous solution 120, which can be in the reactor 100. The sulfur solvent 40 and reaction solution 30 are immiscible and form two different phases, which can be separated due to differences in densities of the two phases.

Sulfur 80 is precipitated from the second stream 70, leaving sulfur solvent 40, which can be recycled to be mixed with the reaction solution 30 including sulfur, forming the sulfur solution 50.

Precipitating sulfur 80 from second stream 70 may include decreasing a temperature of the second stream 70, for example, from 30° C., to 15° C. or 10° C. or lower to precipitate the sulfur 80, leaving sulfur solvent 40.

Decreasing the temperature of the second stream 70 may include transferring heat from the second stream 70 to a cooling solution. Heat gained by the cooling solution may be used to heat the sulfur solvent, for example, using a heat exchanger.

The method may further include separating the hydrogen sulfide from a reservoir fluid. The reservoir fluid may include liquefied petroleum gas, crude oil or petroleum residual fuel, heating oil, a drilling fluid, a servicing fluid, a production fluid, a completion fluid, a rejection fluid, a refinery fluid, wastewater, or a combination thereof. The reservoir fluid may be a production fluid produced from a subterranean formation. The method may further include flowing the production fluid from the subterranean formation into a wellbore.

Set forth below are some embodiments of the foregoing disclosure:
Embodiment 1: A method of producing hydrogen gas and separating sulfur from hydrogen sulfide, the method comprising: contacting the hydrogen sulfide with a catalyst in an aqueous solution to form a hydrogen gas and a reaction solution comprising sulfur; mixing the reaction solution and a sulfur solvent to form a sulfur solution; separating the sulfur solution into a first stream comprising the aqueous solution and a second stream comprising sulfur; and precipitating sulfur from the second stream.
Embodiment 2: The method of any prior embodiment, wherein the catalyst comprises stainless steel, palladium, ruthenium, indium phosphide, molybdenum disulfide, or a combination thereof.
Embodiment 3: The method of any prior embodiment, wherein the aqueous solution comprises monoethanolamine, hydrazine, sodium carbonate, potassium carbonate, ammonium carbonate, or a combination thereof.
Embodiment 4: The method of any prior embodiment, comprising contacting the hydrogen sulfide with the catalyst in the aqueous solution at a temperature of 0 to 200° C.
Embodiment 5: The method of any prior embodiment, wherein the sulfur solvent comprises toluene, 1-butyl-3-methylimidazolium hexafluorophosphate, 1-butyl-3-methylimidazolium tetrafluoroborate, 1-hexyl-3methylimidazolium tetrafluoroborate, carbon disulfide, carbon tetrachloride, quinoline, chlorobenzene, p-xylene, cyclohexane, or a combination thereof.

Embodiment 6: The method of any prior embodiment, wherein the sulfur solvent comprises methanol, water, and a heavy polyamine.

Embodiment 7: The method of any prior embodiment, wherein the sulfur solvent comprises an aromatic solvent, an alcohol, aminoethylpiperazine, and diethylenetriamine.

Embodiment 8: The method of any prior embodiment, wherein the sulfur solvent comprises a polyethylene polyamine, aminoethylpiperazine, a fatty amide, or a combination thereof.

Embodiment 9: The method of any prior embodiment, wherein the sulfur solvent comprises an aromatic, aliphatic hydrocarbon organic solvent.

Embodiment 10: The method of any prior embodiment, wherein the sulfur solvent comprises chlorobenzene, toluene, p-xylene, cyclohexane, or a combination thereof.

Embodiment 11: The method of any prior embodiment, wherein precipitating sulfur from the second stream comprises decreasing a temperature of the second stream to 15° C. or lower to precipitate the sulfur, leaving the sulfur solvent.

Embodiment 12: The method of any prior embodiment, wherein decreasing the temperature of the second stream comprises transferring heat from the sulfur solution to a cooling solution.

Embodiment 13: The method of any prior embodiment, further comprising purifying the first stream to provide the aqueous solution.

Embodiment 14: The method of any prior embodiment, further comprising separating the hydrogen sulfide from a reservoir fluid.

Embodiment 15: The method of any prior embodiment, wherein the reservoir fluid is a production fluid produced from a subterranean formation.

Embodiment 16: The method of any prior embodiment, further comprising flowing the production fluid from the subterranean formation into a wellbore.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of ±8% of a given value.

The teachings of the present disclosure may be used in a variety of well operations. These operations may involve using one or more treatment agents to treat a formation, the fluids resident in a formation, a borehole, and/or equipment in the borehole, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A method of producing hydrogen gas and separating sulfur from hydrogen sulfide, the method comprising:
contacting the hydrogen sulfide with a catalyst in an aqueous solution to form a hydrogen gas and a reaction solution comprising sulfur;
mixing the reaction solution and a sulfur solvent to form a sulfur solution;
separating the sulfur solution into a first stream comprising the aqueous solution and a second stream comprising sulfur; and
precipitating sulfur from the second stream.

2. The method of claim 1, wherein the catalyst comprises stainless steel, palladium, ruthenium, indium phosphide, molybdenum disulfide, or a combination thereof.

3. The method of claim 1, wherein the aqueous solution comprises monoethanolamine, hydrazine, sodium carbonate, potassium carbonate, ammonium carbonate, or a combination thereof.

4. The method of claim 1, comprising contacting the hydrogen sulfide with the catalyst in the aqueous solution at a temperature of 0 to 200° C.

5. The method of claim 1, wherein the sulfur solvent comprises toluene, 1-butyl-3-methylimidazolium hexafluorophosphate, 1-butyl-3-methylimidazolium tetrafluoroborate, 1-hexyl-3methylimidazolium tetrafluoroborate, carbon disulfide, carbon tetrachloride, quinoline, chlorobenzene, p-xylene, cyclohexane, or a combination thereof.

6. The method of claim 1, wherein the sulfur solvent comprises methanol, water, and a heavy polyamine.

7. The method of claim 1, wherein the sulfur solvent comprises an aromatic solvent, an alcohol, aminoethylpiperazine, and diethylenetriamine.

8. The method of claim 1, wherein the sulfur solvent comprises a polyethylene polyamine, aminoethylpiperazine, a fatty amide, or a combination thereof.

9. The method of claim 1, wherein the sulfur solvent comprises an aromatic, aliphatic hydrocarbon organic solvent.

10. The method of claim 1, wherein the sulfur solvent comprises chlorobenzene, toluene, p-xylene, cyclohexane, or a combination thereof.

11. The method of claim 1, wherein precipitating sulfur from the second stream comprises decreasing a temperature of the second stream to 15° C. or lower to precipitate the sulfur, leaving the sulfur solvent.

12. The method of claim 11, wherein decreasing the temperature of the second stream comprises transferring heat from the sulfur solution to a cooling solution.

13. The method of claim 1, further comprising purifying the first stream to provide the aqueous solution.

14. The method of claim 1, further comprising separating the hydrogen sulfide from a reservoir fluid.

15. The method of claim 14, wherein the reservoir fluid is a production fluid produced from a subterranean formation.

16. The method of claim 15, further comprising flowing the production fluid from the subterranean formation into a wellbore.
